(19) United States
(12) Patent Application Publication
(10) Pub. No.: US 2015/0254858 A1
(43) Pub. Date: Sep. 10, 2015

(54) AUTO LEVELING IMAGE CAPTURE OF A HAND-HELD DEVICE

(71) Applicants: Christopher Albury, Roundrock, TX (US); I-Hsing Tsao, Roundrock, TX (US); Elten Logis, Roundrock, TX (US)

(72) Inventors: Christopher Albury, Roundrock, TX (US); I-Hsing Tsao, Roundrock, TX (US); Elten Logis, Roundrock, TX (US)

(73) Assignee: NeuOne, LLC, Austin, TX (US)

(21) Appl. No.: 14/583,022

(22) Filed: Dec. 24, 2014

Related U.S. Application Data
(63) Continuation of application No. 14/197,196, filed on Mar. 4, 2014.

(51) Int. Cl. G06T 7/00; H04N 5/369

(52) U.S. Cl. CPC G06T 7/0042; H04N 5/369; G06T 2207/30244; G06T 2207/10016

(57) ABSTRACT

In some implementations, a mobile device such as a smartphone or a tablet computer, will capture a substantially horizontal image when the user indicates initiation of an auto-leveling-image-capture mode and when an orientation detection component, such as a gyroscope, indicates that the mobile device is horizontal.

### RELATED APPLICATION

This application is a continuation of, and claims the benefit and priority under 35 U.S.C. 120 of U.S. Original patent application Ser. No. 14/197,196 filed 4 Mar. 2014, which is hereby incorporated by reference in its entirety.

### FIELD

This disclosure relates generally to image capture in an orientation by mobile devices, and more particularly to image capture by handheld mobile devices while horizontal.

### BACKGROUND

With the proliferation of smartphones, tablets, and other connected mobile devices, wireless consumers are increasingly using the mobile Web as a primary gateway to the Internet. According to Cisco, the resulting mobile data traffic is growing at 108% from 2010 to 2014 and it is expected to reach 3.6 Petabytes of data per month on 2014, a 25× increase. Current carrier networks that rely solely on 3G or 4G protocol to shoulder the burden of this ever increasing demand are being stretched to the limits of their networks.

A smartphone is a mobile phone built on a mobile operating system, with more advanced computing capability and connectivity than a feature phone. Later models of smartphones include the functionality of portable media players, low-end compact digital cameras, pocket video cameras, and GPS navigation units to form one multi-use device. Conventional smartphones also include high-resolution touchscreens and web browsers that display standard web pages as well as mobile-optimized sites. High-speed data access is provided by Wi-Fi and mobile broadband. One of the most significant differences is that the advanced application programming interfaces (APIs) on smartphones for running third-party applications can allow those applications to have better integration with the phone's OS and hardware than is typical with feature phones.

### BRIEF DESCRIPTION

In one aspect, a mobile device such as a smartphone or a tablet computer, will capture a substantially horizontal image when the user pushes a button that indicates initiation of an auto-leveling-image-capture mode and when an orientation detection component, such as a gyroscope indicates that the mobile device is horizontal.

In another aspect, a mobile device includes a processor, an image transducer that is operably coupled to the processor, an orientation detection component that is operably coupled to the processor, a button that is operably coupled to the processor, and an image-capture-control component that is operable to initiate an image capture by the image transducer in response to a first signal from the button that indicates initiation of an auto-leveling-image-capture mode and in response to a second signal from the orientation detection component that indicates that the mobile device is horizontal within a predetermined extent of accuracy.

In yet another aspect, a hand-held mobile device for capturing an image while the hand-held mobile device is horizontal includes a processor, an image transducer that is operably coupled to the processor, a gyroscope that is operably coupled to the processor, a button that is operably coupled to the processor, and an image-capture-control component that is operable to: receive a first signal from the button that indicates initiation of an auto-leveling-image-capture mode, in response to the first signal from the button that indicates initiation of the auto-leveling-image-capture mode, deactivate function of the image transducer, receive a second signal from the gyroscope that indicates that the hand-held mobile device is horizontal within a predetermined extent of accuracy, and in response to the first signal from the button that indicates initiation of the auto-leveling-image-capture mode and in response to the second signal from the gyroscope that indicates that the hand-held mobile device is horizontal within the predetermined extent of accuracy, activate the image transducer and initiate an image capture by the image transducer.

In still another aspect, a method includes receiving a first signal from a button in a hand-held mobile device that indicates initiation of an auto-leveling-image-capture mode, in response to the first signal from the button that indicates initiation of the auto-leveling-image-capture mode, deactivating function of an image transducer, receiving a second signal from an gyroscope that indicates that the hand-held mobile device is in an orientation within a predetermined extent of accuracy, and in response to the first signal from the button that indicates initiation of the auto-leveling-image-capture mode and in response to the second signal from the gyroscope that indicates that the hand-held mobile device is in the orientation within the predetermined extent of accuracy: activating the image transducer, and initiating an image capture by the image transducer.

### BRIEF DESCRIPTION OF THE DRAWINGS

FIG. 1 is a block diagram of an overview of a hand-held mobile device that captures an image while the hand-held mobile device is horizontal, according to an implementation;

FIG. 2 is a block diagram of a method of capturing an image by a while the mobile device is in a particular orientation, according to an implementation;

FIG. 3 is a block diagram of a method of capturing an image by a while the mobile device is in a particular orientation, according to an implementation;

FIG. 5 is a block diagram of a mobile device to capture an image while the mobile device is horizontal, according to an implementation;

FIG. 6 is a block diagram of a mobile device, according to an implementation;

FIG. 7 is a block diagram of the communication subsystem component, according to an implementation;

FIG. 8 is a block diagram of an accelerometer, according to an implementation;

FIG. 9 is a block diagram of a gyroscope, according to an implementation;

FIG. 10 is a block diagram of a solid-state image transducer, according to an implementation; and

FIG. 11 is a diagram of a display screen of a smartphone while performing method 400, according to an implementation.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, implementations of methods are described. In the third section, implementations of apparatus are described. In the fourth section, hardware and the operating environments in conjunction with which implementations may be practiced are described. Finally, in the fifth section, a conclusion of the detailed description is provided.

### System Level Overview

The system level overview of the operation of an implementation is described in this section of the detailed description.

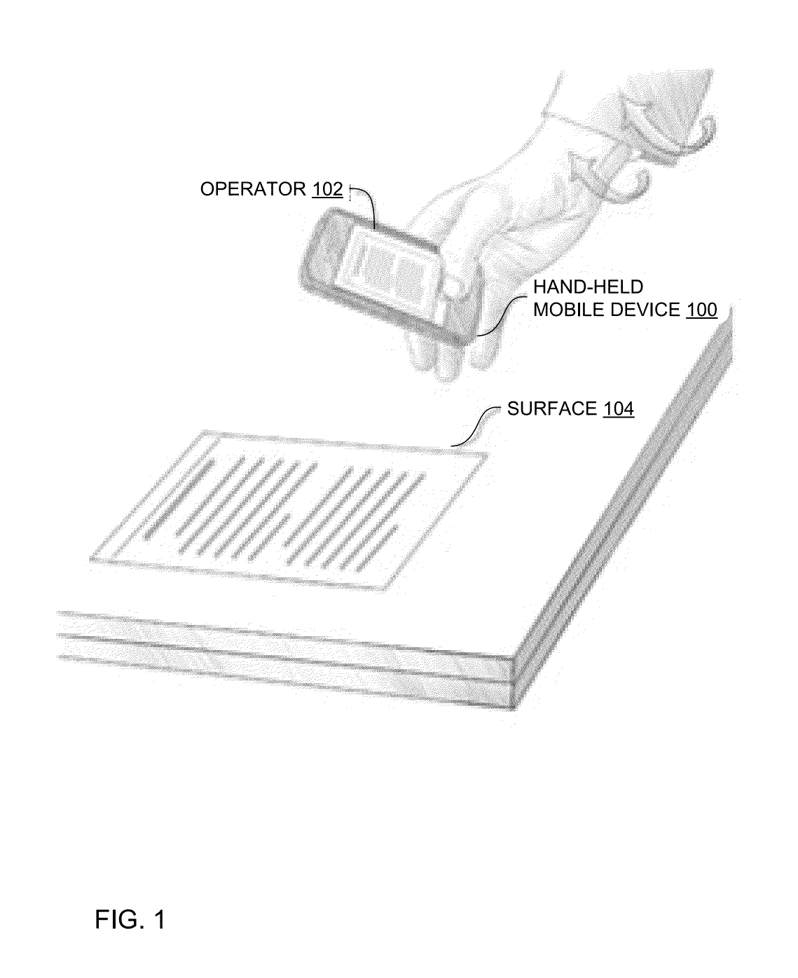

FIG. 1 is a block diagram of an overview of a hand-held mobile device 100 that captures an image while the hand-held mobile device is horizontal, according to an implementation.

Hand-held mobile device 100 captures a substantially horizontal image when the user 102 pushes a button (not shown) that indicates initiation of an auto-leveling-image-capture mode and when an accelerometer (not shown) indicates that the hand-held mobile device 100 is horizontal, the hand-held mobile device 100 captures an image. The purpose of the hand-held mobile device 100 is to capture an image while the hand-held mobile device 100 is substantially “square-on” to a document that is lying on a horizontal surface 104. Operation of the hand-held mobile device 100 with the capability to capture a photo upon detection of a horizontal orientation is much easier and faster than conventional hand-held mobile device that requires the operator to position the mobile device horizontally, and then push an image capture button on the touchscreen. Not only is it difficult for the operator to determine to a high degree of accuracy when the conventional hand-held mobile device is in the orientation, but the physical act of pushing the image capture button typically has the effect of changing the position of the conventional hand-held mobile device and moving the conventional hand-held mobile device out of alignment with the orientation immediately prior to the image capture, thus nearly ensuring that the conventional hand-held mobile device was not squarely aligned with the document on the surface 106, and thus requiring more deskew processing of the image to correct for the misaligned image. Conventional hand-held mobile devices that require the operator to position the mobile device horizontally are positioned horizontally either by placing the hand-held mobile device in a stand that positions the hand-held mobile device in a horizontal position or the hand-held mobile device is held in the hand of the operator in horizontal position. Therefore, FIG. 1-11 describe methods and apparatus that replace the conventional methods and apparatus of positioning the hand-held mobile device in an orientation such as horizontal.

### Method Implementations

In the previous section, a system level overview of the operation of an implementation is described. In this section, the particular methods of such an implementation are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions.

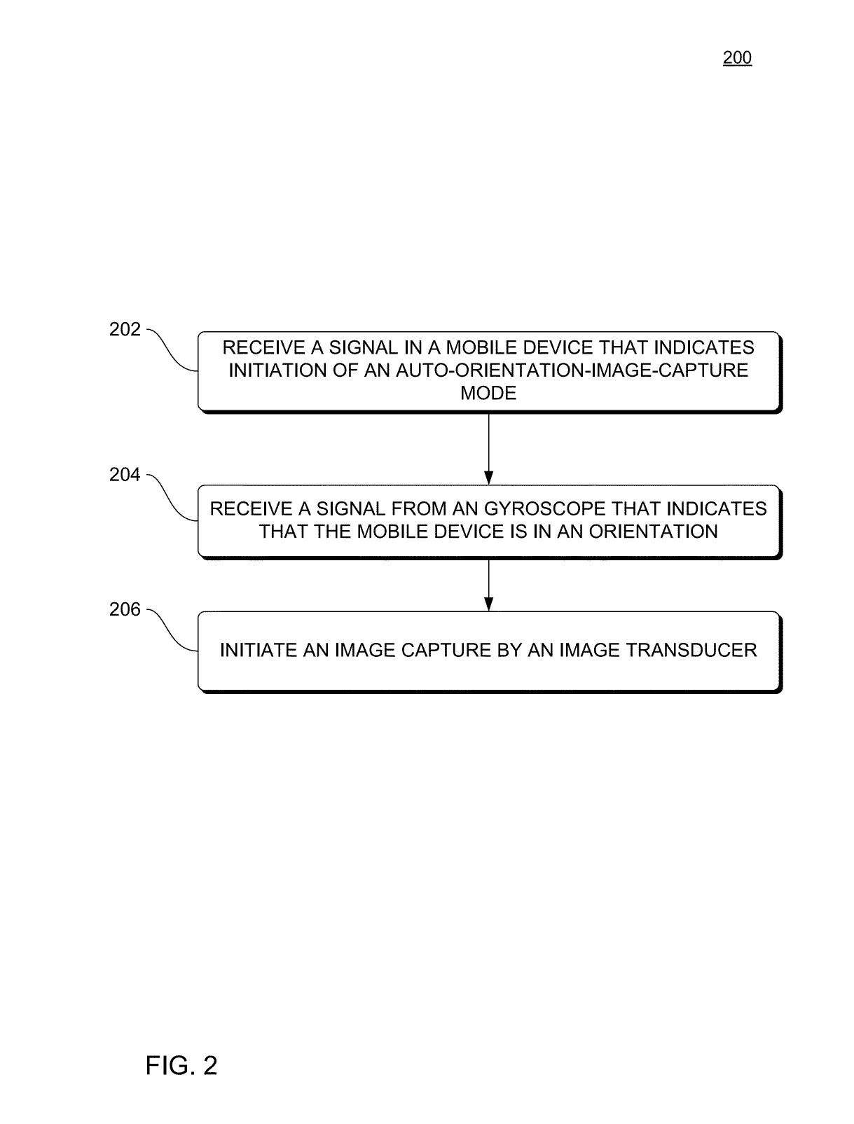

FIG. 2 is a block diagram of a method 200 of capturing an image by a while the mobile device is in a particular orientation, according to an implementation.

Method 200 includes receiving a signal in a mobile device that indicates initiation of an auto-orientation-image-capture mode, at block 202. The signal can be initiated by the operator of the mobile device either by pushing a button (such as a touchscreen button) or by enunciating a audio command the initiate the auto-orientation-image-capture mode.

Thereafter, method 200 also includes receiving a signal from an accelerometer that indicates that the mobile device is in an orientation within a predetermined extent of accuracy, at block 204. The combination of actions 202 and 204 the mobile device in circumstances where the mobile device is ready to capture an image that is substantially aligned along the orientation. The signal that indicates that the mobile device is in the orientation can be received from an accelerometer by a number of techniques, such as polling a flag in a memory location that is set by the accelerometer, or the accelerometer can send a message to an object that is performing the method 200, or the accelerometer can call a function that performs method 200, with a representation of the orientation as a parameter in the function call.

Thereafter, method 200 also includes initiating an image capture by a solid-state image transducer, at block 206. Thereby, the mobile device captures an image that is substantially aligned along the orientation. In implementations where the orientation is horizontal and the mobile device is placed over document on a horizontal table, the captured image is substantially square-on, and requires less deskewing of the captured image, which results in a final image faster, with greater accuracy and with less power. In regards to operator control of the mobile device, after selecting an option on the touchscreen or through speech recognition that indicates initiation of the auto-orientation-image-capture mode at block 202, as the user positions the mobile device into a position that is substantially aligned along the orientation, the mobile device captures an image in action 206. The user could continually adjust the position of the mobile device within a general range of positions that seems to be close to the orientation until the mobile device determines that the mobile device is substantially aligned along the orientation and then immediately initiates the image capture, thereby greatly increasing the productivity of the operator.

Method 200 avoids the difficulties of conventional image capturing systems that required the operator to position the mobile device into the orientation, and then push an image capture button on the touchscreen. In conventional image capturing systems, not only is it difficult for the operator to determine to a high degree of accuracy when the mobile device is in the orientation, but the physical act of pushing the image capture button typically has the effect of changing the position of the mobile device and moving the mobile device out of alignment with the orientation.

Each action of method 200 is performed in the same numerical order of the numbering of the actions. More specifically, action 204 is performed in response to action 206 and action 208 is performed in response to action 206. No other order of performance of the actions in method 200 is operable.

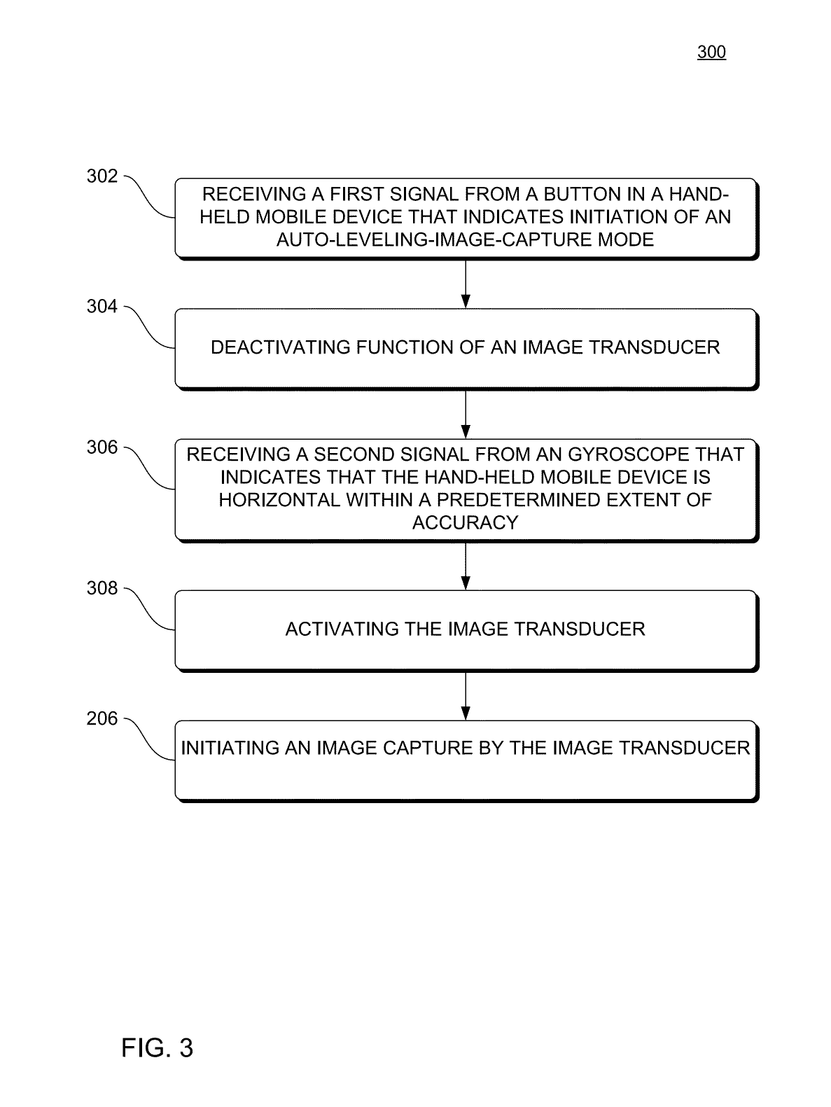

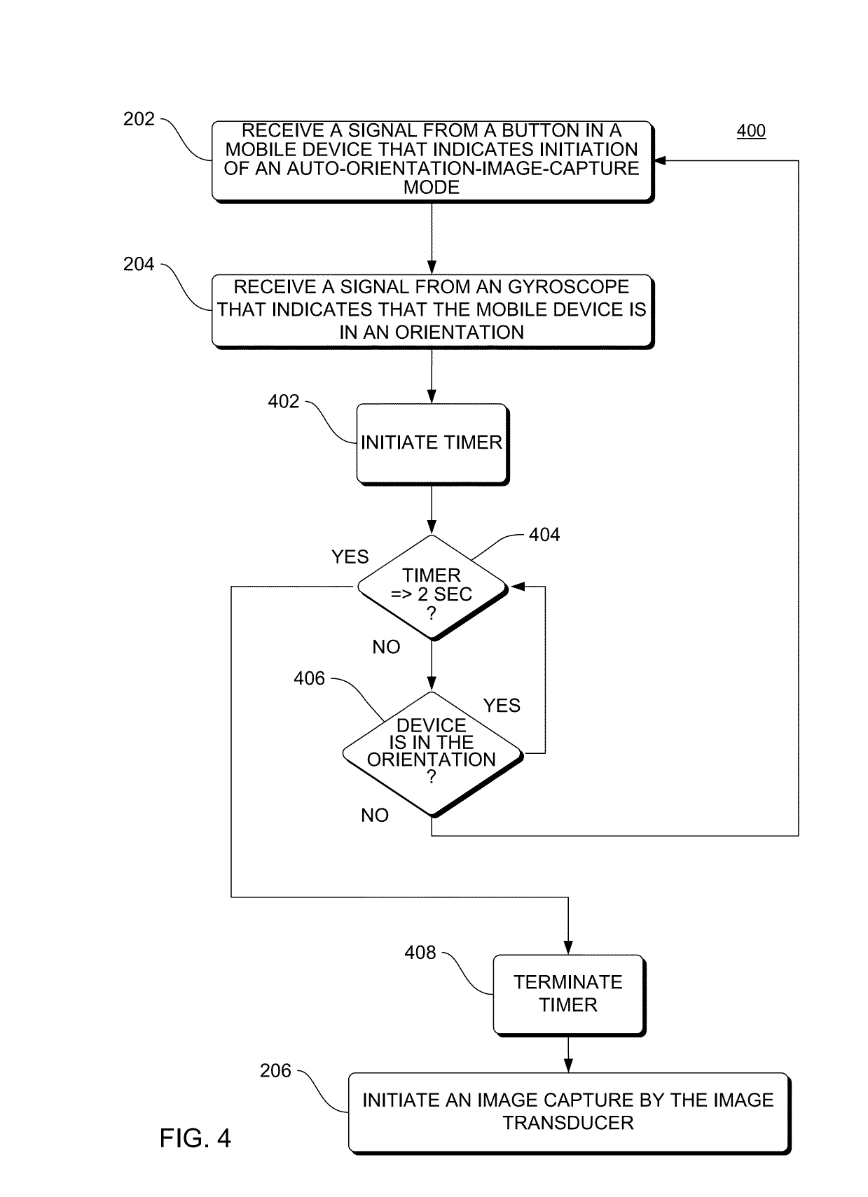

FIG. 3 is a block diagram of a method 300 of capturing an image by a while the mobile device is in a particular orientation, according to an implementation.

Method 300 includes receiving a first signal from a button in a hand-held mobile device that indicates initiation of an auto-leveling-image-capture mode, at block 302.

In some implementations, method 300 includes deactivating function of a solid-state image transducer, at block 304, in response to the first signal from the button that indicates initiation of the auto-leveling-image-capture mode at block 302.

Method 300 includes receiving a second signal from an accelerometer that indicates that the hand-held mobile device is in an orientation within a predetermined extent of accuracy, at block 306.

In some implementations, method 300 includes activating the solid-state image transducer, at block 308, in response to the first signal from the button that indicates initiation of the auto-leveling-image-capture mode at block 302 and in response to the second signal from the accelerometer that indicates that the hand-held mobile device is in the orientation within the predetermined extent of accuracy at block 306.

Thereafter, method 300 also includes initiating an image capture by a solid-state image transducer, at block 206. Thereby, the hand-held mobile device captures an image that is substantially aligned along the horizontal position when the hand-held mobile device is placed over document on a horizontal table, the captured image is substantially square-on, and requires less de-skewing of the captured image, which results in a final image faster, with greater accuracy and with less power. In regards to operator control of the hand-held mobile device, after selecting an option on the touchscreen or through speech recognition that indicates initiation of the auto-leveling-image-capture mode at block 202, as the user positions the hand-held mobile device into a position that is substantially aligned along the horizontal position, the hand-held mobile device captures an image in action 206. The user could continually adjust the position of the hand-held mobile device within a general range of positions that seems to be close to the horizontal position until the hand-held mobile device determines that the hand-held mobile device is substantially aligned along the horizontal position and then immediately initiates the image capture, thereby greatly increasing the productivity of the operator.

Method 300 avoids the difficulties of conventional image capturing systems that required the operator to position the hand-held mobile device into the horizontal position, and then push an image capture button on the touchscreen. In the conventional image capturing systems, not only is it difficult for the operator to determine to a high degree of accuracy when the hand-held mobile device is in the horizontal position, but the physical act of pushing the image capture button typically has the effect of changing the position of the hand-held mobile device and moving the hand-held mobile device out of alignment with the horizontal position.

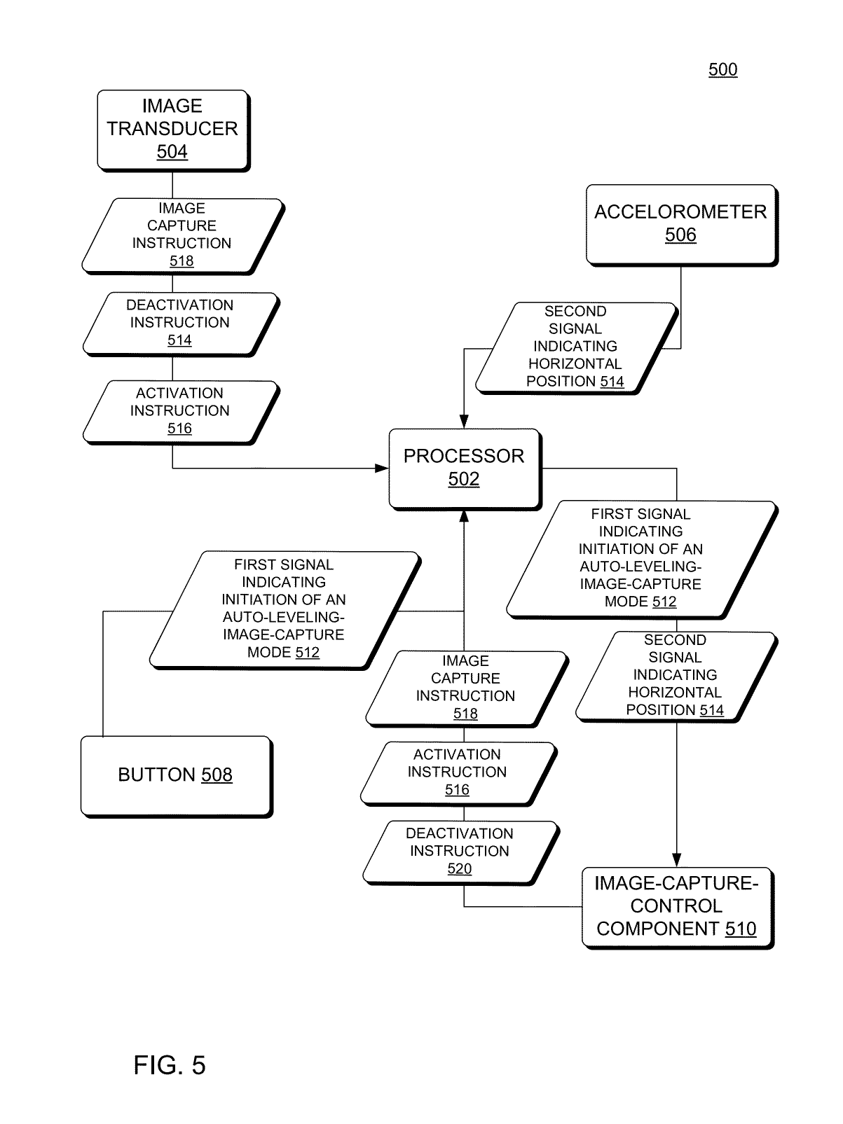

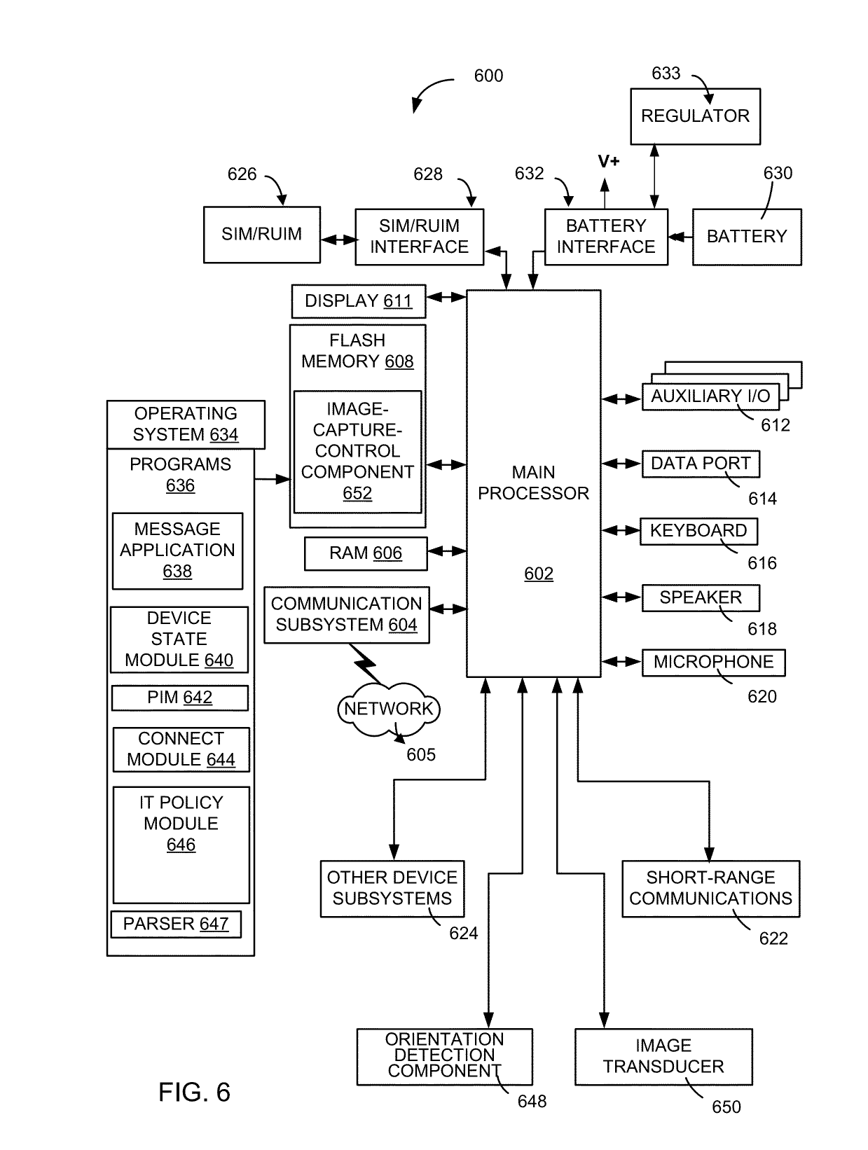

Methods 200, 300 and 400 can be performed by a program executing on, or performed by firmware or hardware that is a part of, a computer, such as mobile device 100 in FIG. 1, hand-held mobile device 500 in FIG. 5 and mobile device 600 in FIG. 6.

FIG. 4 is a block diagram of a method 400 of capturing an image by a while the mobile device is in a particular orientation, according to an implementation.

Method 400 includes receiving a signal in a mobile device that indicates initiation of an auto-orientation-image-capture mode, at block 202.

Thereafter, method 400 also includes receiving a signal from an accelerometer that indicates that the mobile device is in an orientation within a predetermined extent of accuracy, at block 204. The combination of actions 202 and 204 the mobile device in circumstances where the mobile device is ready to capture an image that is substantially aligned along the orientation.

Thereafter a timer is initiated, at block 402.A loop with blocks 404, 406 and 408 begins and is exited only when the device stops being the orientation or when the time runs for at least 2 seconds while the device remains in the orientation. The purpose of the loop is to delay image capture while a focusing-apparatus of the image transducer in the mobile device is focused to provide a focused image for an image transducer. In implementations, where a time other than 2 seconds is required to provide focus, such as 1 second, the loop executes for at least 1 second.

More specifically in the loop, the timer is checked to determine the timer has been running for at least 2 seconds, at block 404. If the timer has not been running for at least 2 seconds, the orientation is checked to determine if the device is in the orientation, at block 406. If the device is in the orientation, the method 400 continues at block 404. If the device is not in the orientation, the method continues at block 202.If the timer has been running for at least 2 seconds, the time is terminated, at block 408.

Thereafter, method 400 also includes initiating an image capture by a solid-state image transducer, at block 206. Thereby, the mobile device captures an image that is substantially aligned along the orientation. In implementations where the orientation is horizontal and the mobile device is placed over document on a horizontal table, the captured image is substantially square-on, and requires less deskewing of the captured image, which results in a final image faster, with greater accuracy and with less power. In regards to operator control of the mobile device, after selecting an option on the touchscreen or through speech recognition that indicates initiation of the auto-orientation-image-capture mode at block 202, as the user positions the mobile device into a position that is substantially aligned along the orientation, the mobile device captures an image in action 206. Method 400 avoids the difficulties of conventional image capturing systems that required the operator to position the mobile device into the orientation, and then push an image capture button on the touchscreen. In conventional image capturing systems, not only is it difficult for the operator to determine to a high degree of accuracy when the mobile device is in the orientation, but the physical act of pushing the image capture button typically has the effect of changing the position of the mobile device and moving the mobile device out of alignment with the orientation.

### Apparatus

FIG. 5 is a block diagram of a mobile device 500 to capture an image while the mobile device is horizontal, according to an implementation.

The mobile device 500 includes a processor, such as main processor 602 in FIG. 6.

The mobile device 500 also includes a solid-state image transducer 504 that is operably coupled to the processor 502.

The mobile device 500 also includes an accelerometer 506 that is operably coupled to the processor 502.

The mobile device 500 also includes a button 508 that is operably coupled to the processor 502.

The mobile device 500 also includes an image-capture-control component 510. The image-capture-control component 510 is operable to receive a first signal 512 from the button 508. The first signal 512 indicates initiation of an auto-leveling-image-capture mode.

In response to the first signal 512 from the button 508 that indicates initiation of the auto-leveling-image-capture mode the image-capture-control component 510 is operable to deactivate 520 function of the solid-state image transducer 504.

The image-capture-control component 510 is operable to receive a second signal 514 from the accelerometer 506 that indicates that the mobile device is horizontal within a predetermined extent of accuracy.

The image-capture-control component 510 is operable to activate 516 the solid-state image transducer 504 and initiate an image capture 518 by the solid-state image transducer 504, in response the first signal 512 from the button 508 that indicates initiation of the auto-leveling-image-capture mode, and in response to the second signal 514 from the accelerometer 506 that indicates that the mobile device 500 is horizontal within the predetermined extent of accuracy.

In some implementations, the image-capture-control component 510 is stored on flash memory 608 in FIG. 6 and loaded into the main processor 602.

Mobile device 100 in FIG. 1 and mobile device 600 in FIG. 6 are examples of the mobile device of FIG. 5.

### Hardware and Operating Environment

FIG. 6 is a block diagram of a hardware and operating environment in which different implementations can be practiced. The descriptions provide an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

The implementations described herein generally relate to a mobile wireless communication device, hereafter referred to as a mobile device, which can be configured according to an IT policy. It should be noted that the term IT policy, in general, refers to a collection of IT policy rules, in which the IT policy rules can be defined as being either grouped or non-grouped and global or per-user. The terms grouped, non-grouped, global and per-user are defined further below. Examples of applicable communication devices include pagers, cellular phones, cellular smart-phones, wireless organizers, personal digital assistants, computers, laptops, handheld wireless communication devices, wirelessly enabled notebook computers and the like.

FIG. 6 is a block diagram of a mobile device 600, according to an implementation. The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

Mobile device 600 is one implementation of mobile device 100 in FIG. 1. The mobile device 600 includes a number of components such as a main processor 602 that controls the overall operation of the mobile device 600. Communication functions, including data and voice communications, are performed through a communication subsystem 604. The communication subsystem 604 receives messages from and sends messages to wireless networks 605. The wireless networks 605 include the 3G/4G network 110 in FIG. 1. In other implementations of the mobile device 600, the communication subsystem 604 can be configured in accordance with the Global System for Mobile Communication (GSM), General Packet Radio Services (GPRS), Enhanced Data GSM Environment (EDGE), Universal Mobile Telecommunications Service (UMTS), data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include Mobitex™ and DataTAC™ network communication systems. Examples of other voice-centric data networks include Personal Communication Systems (PCS) networks like GSM and Time Division Multiple Access (TDMA) systems.

The wireless link connecting the communication subsystem 604 with the wireless network 605 represents one or more different Radio Frequency (RF) channels. With newer network protocols, these channels are capable of supporting both circuit switched voice communications and packet switched data communications.

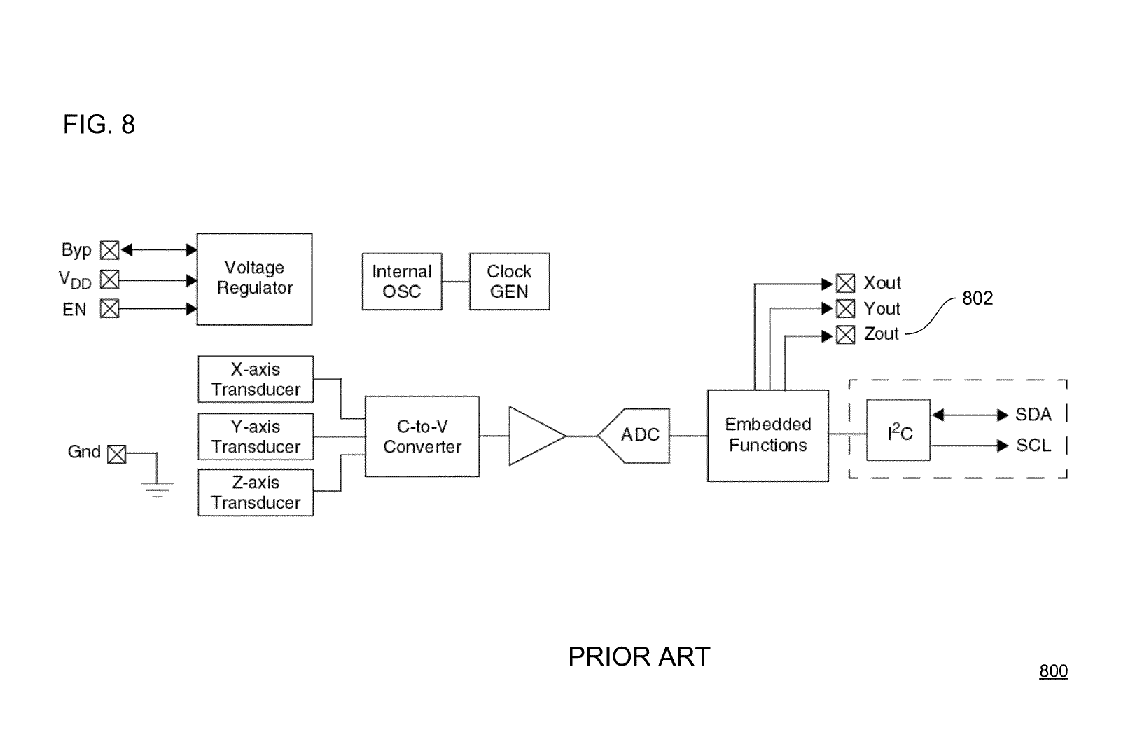

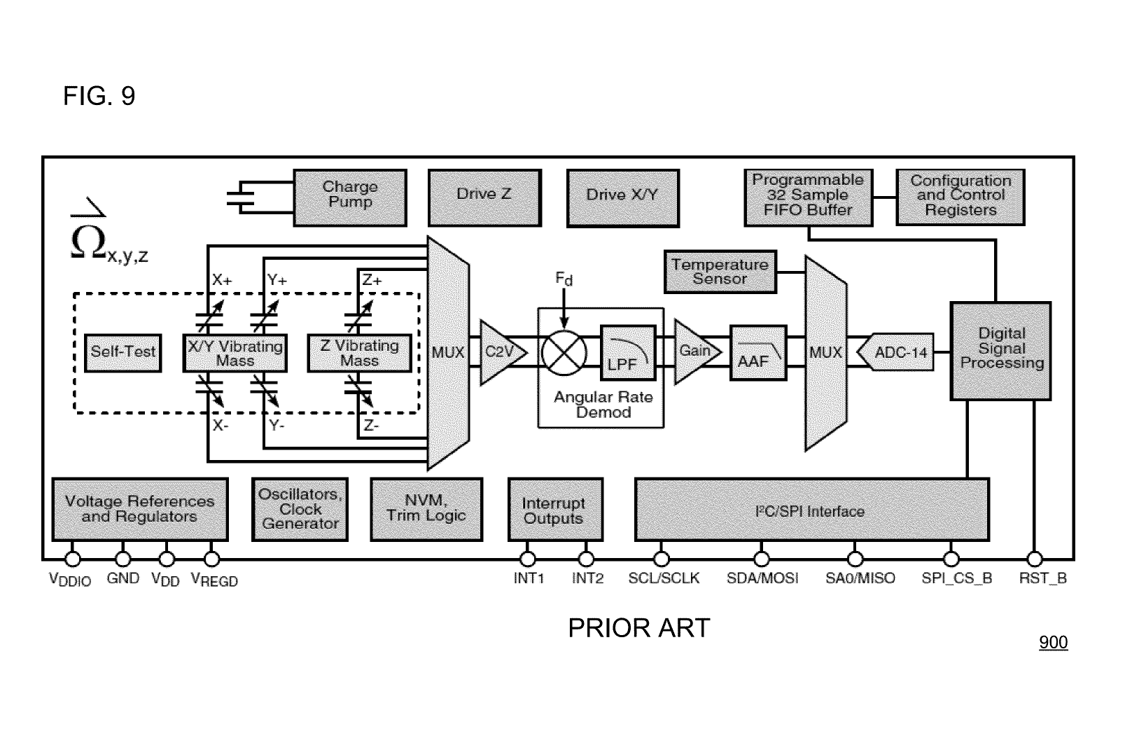

The main processor 602 also interacts with additional subsystems such as a Random Access Memory (RAM) 606, a flash memory 608, a display 610, an auxiliary input/output (I/O) subsystem 612, a data port 614, a keyboard 616, a speaker 618, a microphone 620, short-range communications 622, other device subsystems 624, an orientation detection component 648 such as accelerometer 800 in FIG. 8 or gyroscope 900 in FIG. 9, and at least one solid-state image transducer 650. In some implementations, the flash memory 608 includes an image-capture-control component, such as image-capture-control component 510 in FIG. 5.

Some of the subsystems of the mobile device 600 perform communication-related functions, whereas other subsystems may provide “resident” or on-device functions. By way of example, the display 610 and the keyboard 616 may be used for both communication-related functions, such as entering a text message for transmission over the wireless network 605, and device-resident functions such as a calculator or task list.

The mobile device 600 can transmit and receive communication signals over the wireless network 605 after required network registration or activation procedures have been completed. Network access is associated with a subscriber or user of the mobile device 600. To identify a subscriber, the mobile device 600 requires a SIM/RUIM card 626 (i.e. Subscriber Identity Module or a Removable User Identity Module) to be inserted into a SIM/RUIM interface 628 in order to communicate with a network. The SIM card or RUIM 626 is one type of a conventional “smart card” that can be used to identify a subscriber of the mobile device 600 and to personalize the mobile device 600, among other things. Without the SIM card 626, the mobile device 600 is not fully operational for communication with the wireless network 605. By inserting the SIM card/RUIM 626 into the SIM/RUIM interface 628, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 626 includes a processor and memory for storing information. Once the SIM card/RUIM 626 is inserted into the SIM/RUIM interface 628, it is coupled to the main processor 602. In order to identify the subscriber, the SIM card/RUIM 626 can include some user parameters such as an International Mobile Subscriber Identity (IMSI). An advantage of using the SIM card/RUIM 626 is that a subscriber is not necessarily bound by any single physical mobile device. The SIM card/RUIM 626 may store additional subscriber information for a mobile device as well, including datebook (or calendar) information and recent call information. Alternatively, user identification information can also be programmed into the flash memory 608.

The mobile device 600 is a battery-powered device and includes a battery interface 632 for receiving one or more batteries 630. In one or more implementations, the battery 630 can be a smart battery with an embedded microprocessor. The battery interface 632 is coupled to a regulator 633, which assists the battery 630 in providing power V+to the mobile device 600. Although current technology makes use of a battery, future technologies such as micro fuel cells may provide the power to the mobile device 600.

The mobile device 600 also includes an operating system 634 and software components 636 to 646 which are described in more detail below. The operating system 634 and the software components 636 to 646 that are executed by the main processor 602 are typically stored in a persistent store such as the flash memory 608, which may alternatively be a read-only memory (ROM) or similar storage element (not shown). Those skilled in the art will appreciate that portions of the operating system 634 and the software components 636 to 646, such as specific device applications, or parts thereof, may be temporarily loaded into a volatile store such as the RAM 606. Other software components can also be included.

The subset of software applications 636 that control basic device operations, including data and voice communication applications, will normally be installed on the mobile device 600 during its manufacture. Other software applications include a message application 638 that can be any suitable software program that allows a user of the mobile device 600 to transmit and receive electronic messages. Various alternatives exist for the message application 638 as is well known to those skilled in the art. Messages that have been sent or received by the user are typically stored in the flash memory 608 of the mobile device 600 or some other suitable storage element in the mobile device 600. In one or more implementations, some of the sent and received messages may be stored remotely from the device 600 such as in a data store of an associated host system with which the mobile device 600 communicates.

The software applications can further include a device state module 640, a Personal Information Manager (PIM) 642, and other suitable modules (not shown). The device state module 640 provides persistence, i.e. the device state module 640 ensures that important device data is stored in persistent memory, such as the flash memory 608, so that the data is not lost when the mobile device 600 is turned off or loses power.

The PIM 642 includes functionality for organizing and managing data items of interest to the user, such as, but not limited to, e-mail, contacts, calendar events, voice mails, appointments, and task items. A PIM application has the ability to transmit and receive data items via the wireless network 605. PIM data items may be seamlessly integrated, synchronized, and updated via the wireless network 605 with the mobile device subscriber's corresponding data items stored and/or associated with a host computer system. This functionality creates a mirrored host computer on the mobile device 600 with respect to such items. This can be particularly advantageous when the host computer system is the mobile device subscriber's office computer system.

The mobile device 600 also includes a connect module 644, and an IT policy module 646. The connect module 644 implements the communication protocols that are required for the mobile device 600 to communicate with the wireless infrastructure and any host system, such as an enterprise system, with which the mobile device 600 is authorized to interface. Examples of a wireless infrastructure and an enterprise system are given in FIGS. 21 and 22, which are described in more detail below.

The connect module 644 includes a set of APIs that can be integrated with the mobile device 600 to allow the mobile device 600 to use any number of services associated with the enterprise system. The connect module 644 allows the mobile device 600 to establish an end-to-end secure, authenticated communication pipe with the host system. A subset of applications for which access is provided by the connect module 644 can be used to pass IT policy commands from the host system to the mobile device 600. This can be done in a wireless or wired manner. These instructions can then be passed to the IT policy module 646 to modify the configuration of the device 600. Alternatively, in some cases, the IT policy update can also be done over a wired connection.

The IT policy module 646 receives IT policy data that encodes the IT policy. The IT policy module 646 then ensures that the IT policy data is authenticated by the mobile device 600. The IT policy data can then be stored in the flash memory 608 in its native form. After the IT policy data is stored, a global notification can be sent by the IT policy module 646 to all of the applications residing on the mobile device 600. Applications for which the IT policy may be applicable then respond by reading the IT policy data to look for IT policy rules that are applicable.

The IT policy module 646 can include a parser 647, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 646 can determine which applications are affected by the IT policy data and transmit a notification to only those applications. In either of these cases, for applications that are not being executed by the main processor 602 at the time of the notification, the applications can call the parser or the IT policy module 646 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 646 sends an acknowledgement back to the host system to indicate that the IT policy data was received and successfully applied.

One implementation of the accelerometer 648 is shown in FIG. 8 below and one example of a solid-state image transducer 650 is shown in FIG. 9 below.

Other types of software applications can also be installed on the mobile device 600. These software applications can be third party applications, which are added after the manufacture of the mobile device 600. Examples of third party applications include games, calculators, utilities, etc.

The additional applications can be loaded onto the mobile device 600 through at least one of the wireless network 605, the auxiliary I/O subsystem 612, the data port 614, the short-range communications subsystem 622, or any other suitable device subsystem 624. This flexibility in application installation increases the functionality of the mobile device 600 and may provide enhanced on-device functions, communication-related functions, or both. For example, secure communication applications may enable electronic commerce functions and other such financial transactions to be performed using the mobile device 600.

The data port 614 enables a subscriber to set preferences through an external device or software application and extends the capabilities of the mobile device 600 by providing for information or software downloads to the mobile device 600 other than through a wireless communication network. The alternate download path may, for example, be used to load an encryption key onto the mobile device 600 through a direct and thus reliable and trusted connection to provide secure device communication.

The data port 614 can be any suitable port that enables data communication between the mobile device 600 and another computing device. The data port 614 can be a serial or a parallel port. In some instances, the data port 614 can be a USB port that includes data lines for data transfer and a supply line that can provide a charging current to charge the battery 630 of the mobile device 600.

The short-range communications subsystem 622 provides for communication between the mobile device 600 and different systems or devices, without the use of the wireless network 605. For example, the subsystem 622 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 604 and input to the main processor 602. The main processor 602 will then process the received signal for output to the display 610 or alternatively to the auxiliary I/O subsystem 612. A subscriber may also compose data items, such as e-mail messages, for example, using the keyboard 616 in conjunction with the display 610 and possibly the auxiliary I/O subsystem 612. The auxiliary subsystem 612 may include devices such as: a touch screen, mouse, track ball, infrared fingerprint detector, or a roller wheel with dynamic button pressing capability. The keyboard 616 is preferably an alphanumeric keyboard and/or telephone-type keypad. However, other types of keyboards may also be used. A composed item may be transmitted over the wireless network 605 through the communication subsystem 604.

For voice communications, the overall operation of the mobile device 600 is substantially similar, except that the received signals are output to the speaker 618, and signals for transmission are generated by the microphone 620. Alternative voice or audio I/O subsystems, such as a voice message recording subsystem, can also be implemented on the mobile device 600. Although voice or audio signal output is accomplished primarily through the speaker 618, the display 610 can also be used to provide additional information such as the identity of a calling party, duration of a voice call, or other voice call related information.

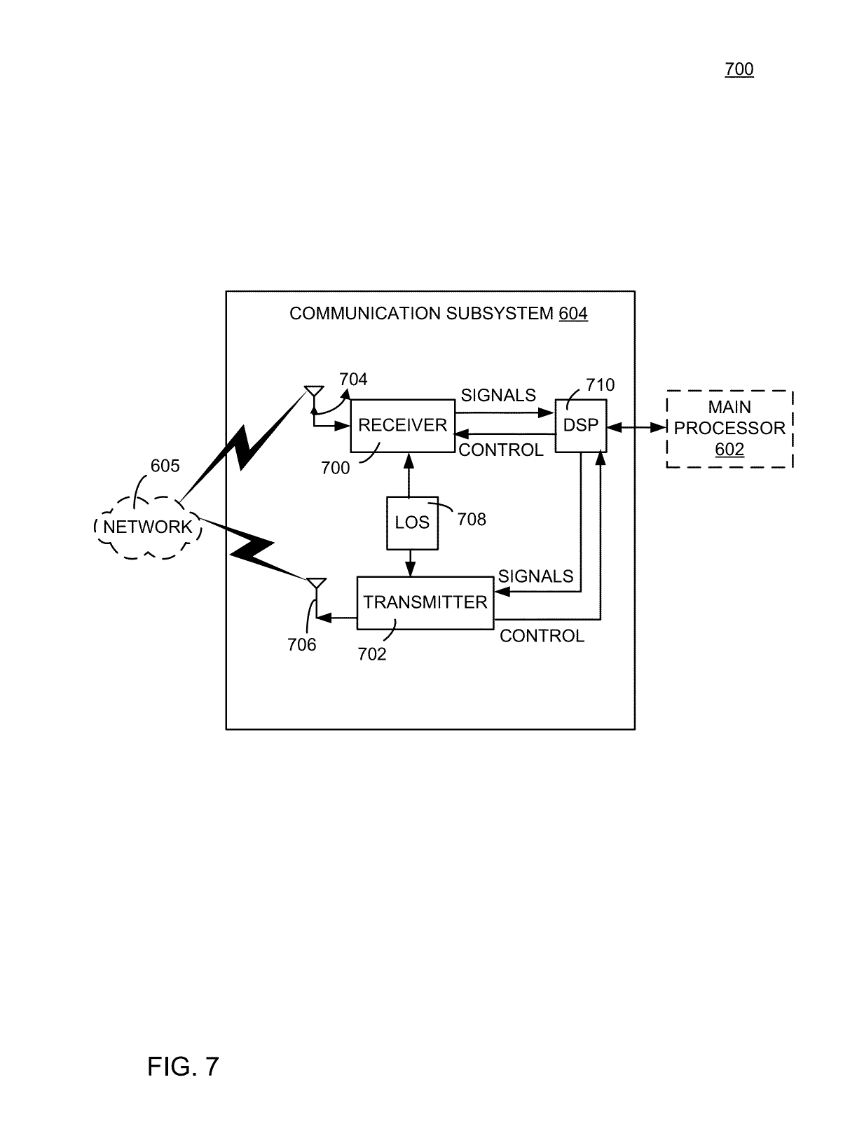

FIG. 7 is a block diagram of the communication subsystem component 604 is shown, according to an implementation. The communication subsystem 604 includes a receiver 700, a transmitter 702, as well as associated components such as one or more embedded or internal antenna elements 704 and 706, Local Oscillators (LOs) 708, and a processing module such as a Digital Signal Processor (DSP) 710. The particular implementation of the communication subsystem 604 is dependent upon the communication wireless network 605 with which the mobile device 600 is intended to operate. Thus, it should be understood that the implementation illustrated in FIG. 7 serves only as one example.

Signals received by the antenna 704 through the wireless network 605 are input to the receiver 700, which may perform such common receiver functions as signal amplification, frequency down conversion, filtering, channel selection, and analog-to-digital (A/D) conversion. A/D conversion of a received signal allows more complex communication functions such as demodulation and decoding to be performed in the DSP 710. In a similar manner, signals to be transmitted are processed, including modulation and encoding, by the DSP 710. These DSP-processed signals are input to the transmitter 702 for digital-to-analog (DIA) conversion, frequency up conversion, filtering, amplification and transmission over the wireless network 605 via the antenna 706. The DSP 710 not only processes communication signals, but also provides for receiver and transmitter control. For example, the gains applied to communication signals in the receiver 700 and the transmitter 702 may be adaptively controlled through automatic gain control algorithms implemented in the DSP 710.

The wireless link between the mobile device 600 and the wireless network 605 can contain one or more different channels, typically different RF channels, and associated protocols used between the mobile device 600 and the wireless network 605. An RF channel is a limited resource that must be conserved, typically due to limits in overall bandwidth and limited battery power of the mobile device 600.

When the mobile device 600 is fully operational, the transmitter 702 is typically keyed or turned on only when it is transmitting to the wireless network 605 and is otherwise turned off to conserve resources. Similarly, the receiver 700 is periodically turned off to conserve power until the receiver 700 is needed to receive signals or information (if at all) during designated time periods.

FIG. 8 is a block diagram of an accelerometer 800, according to an implementation. The tilt of the accelerometer 800 is signaled through the Zout port 802 (pin 1 on the accelerometer 800). When the accelerometer 800 is flat (horizontal) the Zout port702 port is set to 1.

FIG. 9 is a block diagram of a gyroscope 900, according to an implementation.

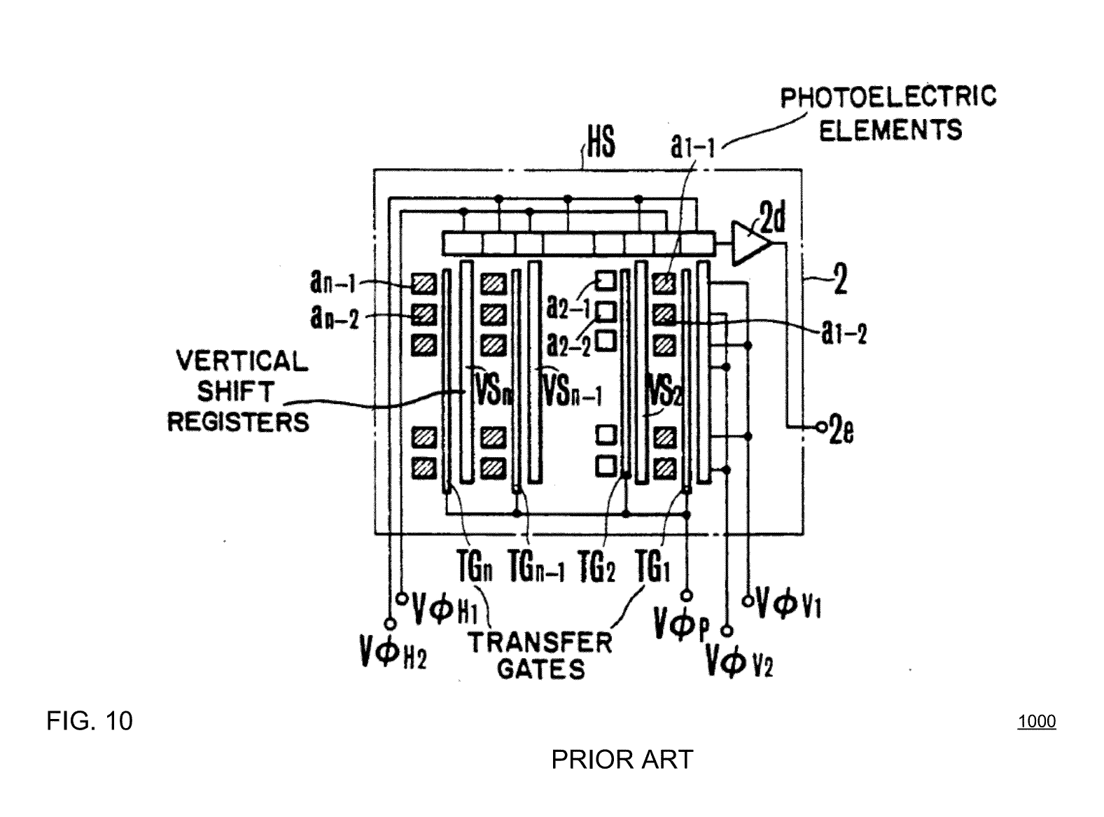

FIG. 10 is a block diagram of a solid-state image transducer 1000, according to an implementation. The image transducer 1000 is constructed as comprising a great number of photoelectric elements, a.sub.1.sub.1, a.sub.2.sub.1, . . . , a.sub.mn, in the minute segment form, transfer gates TG1, TG2, . . . , TGn responsive to a control pulse V.sub.φP for transferring the charges stored on the individual photoelectric elements as an image signal to vertical shift registers VS1, VS2, . . . , VSn, and a horizontal shift register HS for transferring the image signal from the vertical shift registers VSs, through a buffer amplifier 2d to an outlet 2e. After the one-frame image signal is stored, the image signal is transferred to vertical shift register by the pulse V.sub.φP and the contents of the vertical shift registers VSs are transferred upward line by line in response to a series of control pulses V.sub.φV1, V.sub.φV2. During the time interval between the successive two vertical transfer control pulses, the horizontal shift register HS responsive to a series of control pulses V.sub.φH1, V.sub.φH2 transfers the contents of the horizontal shift registers HSs in each line row by row to the right as viewed in the figure. As a result, the one-frame image signal is formed by reading out the outputs of the individual photoelectric elements in such order.

Communication media typically embodies computer-readable instructions, data structures and program modules.

By way of example, and not limitation, communication media include wired media, such as wired network or direct-wired connections, and wireless media, such as acoustic, RF, infrared and other wireless media. The scope of the term computer-readable media includes combinations of any of the above.

More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI).

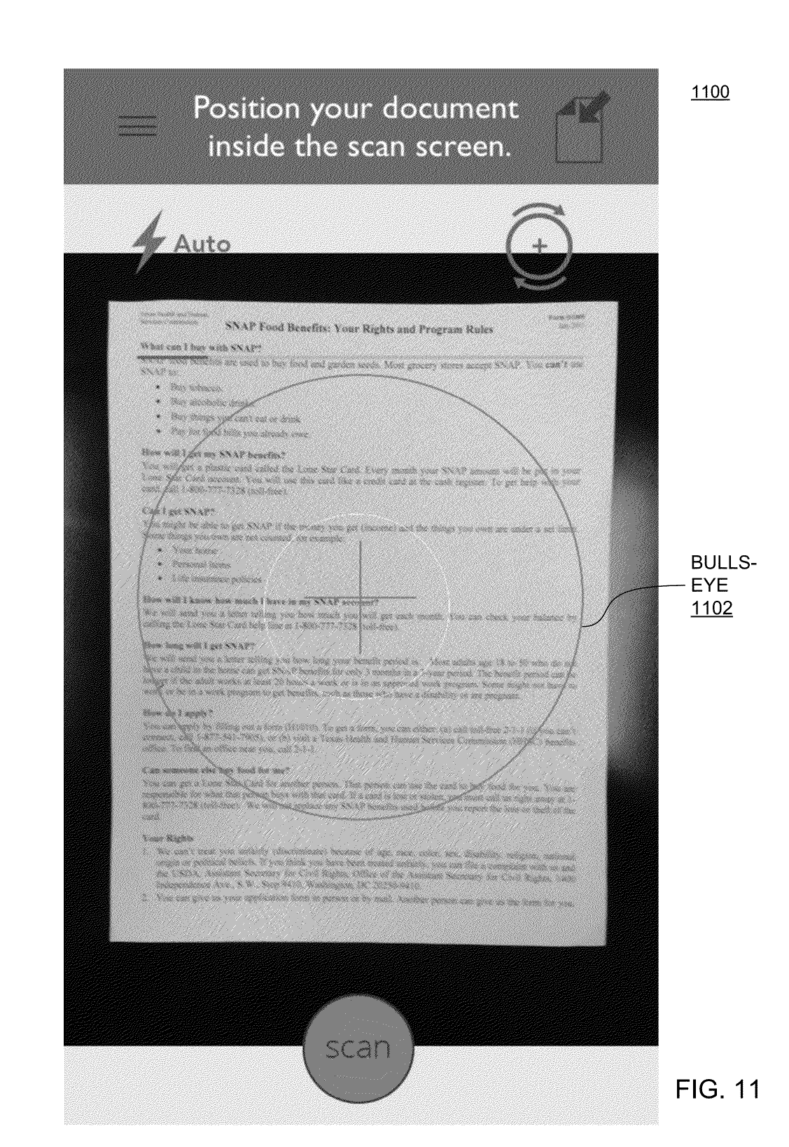

FIG. 11 is a diagram 1100 of a display screen of a smartphone while performing method 400, according to an implementation. The diagram includes a bulls-eye 1102 that assists the operator of the smartphone in aiming the image transducer of the smartphone during the loop of blocks 404 and 406.

### CONCLUSION

A mobile device that captures images when the mobile device is positioned in a particular orientation is described. A technical effect of the mobile device is to capture images when the mobile device is positioned in a particular orientation. Although specific implementations have been illustrated and described herein, it will be appreciated by those of ordinary skill in the art that any arrangement which is calculated to achieve the same purpose may be substituted for the specific implementations shown. This disclosure is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future image transducers, new orientation detection components, and different orientations.

The terminology used in this application is meant to include all wireless mobile devices, orientation detection components and image transducers and alternate technologies which provide the same functionality as described herein.

1. A hand-held mobile device for capturing an image while the hand-held mobile device is horizontal, the hand-held mobile device comprising:
a processor;
a solid-state image transducer that is operably coupled to the processor;
a gyroscope that is operably coupled to the processor;
a button that is operably coupled to the processor; and
an image-capture-control component that is operable to:
receive a first signal from the button that indicates initiation of an auto-leveling-image-capture mode;
in response to the first signal from the button that indicates initiation of the auto-leveling-image-capture mode, deactivate function of the solid-state image transducer;
receive a second signal from the gyroscope that indicates that the hand-held mobile device is horizontal within a predetermined extent of accuracy; and
in response to the first signal from the button that indicates initiation of the auto-leveling-image-capture mode and in response to the second signal from the gyroscope that indicates that the hand-held mobile device is horizontal within the predetermined extent of accuracy, activate the solid-state image transducer and initiate an image capture by the image transducer.

2. The hand-held mobile device of claim 1 wherein the button further comprises:
a graphical image icon being displayed on a touchscreen of the hand-held mobile device.

3. The hand-held mobile device of claim 1 wherein the button further comprises:
a physical button operably coupled to the processor of the hand-held mobile device.

4. A mobile device comprising:
a processor;
a solid-state image transducer that is operably coupled to the processor;
an orientation detection component that is operably coupled to the processor;
a button that is operably coupled to the processor; and
an image-capture-control component that is operable to:
in response to a first signal from the button that indicates initiation of an auto-leveling-image-capture mode and in response to a second signal from the orientation detection component that indicates that the mobile device is horizontal within a predetermined extent of accuracy, initiate an image capture by the solid-state image transducer.

5. The mobile device of claim 4 wherein the image-capture-control component that is further operable to:
in response to the first signal from the button that indicates initiation of the auto-leveling-image-capture mode, deactivate the solid-state image transducer.

6. The mobile device of claim 5 wherein the image-capture-control component that is further operable to:
in response to the second signal from the orientation detection component that indicates that the mobile device is horizontal within the predetermined extent of accuracy, activate the solid-state image transducer before initiate the image capture by the solid-state image transducer.

7. The mobile device of claim 4 wherein the button further comprises:
a graphical image icon being displayed on a touchscreen of the mobile device.

8. The mobile device of claim 4 wherein the button further comprises:
a physical button operably coupled to the processor of the mobile device.

9. The mobile device of claim 4 wherein the orientation detection component further comprises:
a gyroscope.

10. The mobile device of claim 4 wherein the orientation detection component further comprises:
a gyroscope.

11. The mobile device of claim 4 wherein the mobile device further comprises:
a hand-held mobile device.

12. The mobile device of claim 4 wherein the mobile device further comprises:
a tablet computer.

13. A method comprising:
receiving a first signal from a button in a hand-held mobile device that indicates initiation of an auto-leveling-image-capture mode;
in response to the first signal from the button that indicates initiation of the auto-leveling-image-capture mode, deactivating function of a solid-state image transducer;
receiving a second signal from a gyroscope that indicates that the hand-held mobile device is in an orientation within a predetermined extent of accuracy; and
in response to the first signal from the button that indicates initiation of the auto-leveling-image-capture mode and in response to the second signal from the gyroscope that indicates that the hand-held mobile device is in the orientation within the predetermined extent of accuracy:
activating the solid-state image transducer; and
initiating an image capture by the solid-state image transducer.

14. The method of claim 13 wherein the image-capture-control component that is further operable to:
in response to the first signal from the button that indicates initiation of the auto-leveling-image-capture mode, deactivating the solid-state image transducer.

15. The method of claim 14 wherein the image-capture-control component that is further operable to:
in response to the second signal from the gyroscope that indicates that the mobile device is horizontal within the predetermined extent of accuracy, activating the solid-state image transducer before initiating the image capture by the solid-state image transducer.

16. The method of claim 13 wherein the orientation further comprises:
a horizontal orientation.

17. The method of claim 13 wherein the orientation further comprises:
a vertical orientation.
